(19) United States
(12) Patent Application Publication
(10) Pub. No.: US 2019/0331074 A1
(43) Pub. Date: Oct. 31, 2019

(54) CARE-FREE ACTIVATION SYSTEM OF ELECTRICALLY CONTROLLED COMMON RAIL ENGINE

(71) Applicant: GUANGXI YUCHAI MACHINERY GROUP CO., LTD., Guangxi (CN)

(72) Inventors: Guirong TAN, Guangxi (CN); Zonghua MO, Guangxi (CN); Guoqiang HU, Guangxi (CN); Jian ZHOU, Guangxi (CN); Junhong CHEN, Guangxi (CN); Buwu SUN, Guangxi (CN); Zengliang ZHAO, Guangxi (CN); Huan LI, Guangxi (CN); Yangjun CAO, Guangxi (CN); Xueguang WANG, Guangxi (CN)

(73) Assignee: GUANGXI YUCHAI MACHINERY GROUP CO., LTD., Guangxi (CN)

(21) Appl. No.: 16/468,294

(22) PCT Filed: Oct. 23, 2017
(86) PCT No.: PCT/CN2017/106273

§ 371 Date: Jun. 11, 2019

(30) Foreign Application Priority Data
Feb. 17, 2017 (CN) 201710088361.X

(51) Int. Cl. F02M 37/20; F02M 37/32

(52) U.S. Cl. CPC F02M 37/20; F02M 37/32

(57) ABSTRACT

A care-free activation system of an electrically controlled common rail engine. The care-free activation system includes a fuel tank, a fuel transfer pump and a fine filter. A gas discharging device discharging fuel gas is arranged between the fuel transfer pump and the fine filter. An outlet of the gas discharging device communicates with the fuel tank via an oil pipe. In the care-free activation system of the electrically controlled common rail engine, by arranging the gas discharging device at an oil feeding port of a fine filter, air in the fine filter can be discharged via the gas discharging device, thereby implementing active gas discharging, and effectively increasing activation performance of the engine.

### BACKGROUND OF THE INVENTION

### 1. Field of the Invention

The present invention relates to the field of engines, in particular, to a care-free activation system of an electrically controlled common rail engine.

### 2. Description of Related Art

In an existing electrically controlled common rail engine, a fuel system is an important factor affecting activation performance thereof. At present, an existing common rail system mainly improves the activation performance of an engine by optimizing system components and optimizing a complete machine layout design. However, these methods cannot completely solve the problem of long activation time or failure in activation. An electronic fuel transfer pump is added to some engines to speed up gas discharging of an oil channel, so a purpose of speeding up the activation can be achieved, and complete machine costs may be increased. Meanwhile, it is not recognized in the prior art that presence of gas from a fuel transfer pump to a fuel injection pump affects the activation performance.

### SUMMARY OF THE INVENTION

The present invention is directed to a care-free activation system of an electrically controlled common rail engine, which can effectively increase activation performance of the engine.

To this end, a care-free activation system of an electrically controlled common rail engine is provided. The system includes a fuel tank, a fuel transfer pump, a fine filter, and a fuel injection pump. A gas discharging device discharging fuel gas is arranged on an oil channel between an oil outlet of the fuel transfer pump and an oil inlet of the fuel injection pump. An outlet of the gas discharging device communicates with the fuel tank via an oil pipe.

Preferably, the gas discharging device is a one-way valve.

Preferably, an opening pressure of the gas discharging device is between 1.5 bar and 6 bar.

Preferably, the gas discharging device includes a valve body, a valve body inlet provided at one end of the valve body, and a gas discharging hole provided on a side surface of the valve body. The valve body inlet communicates with the oil channel between the oil outlet of the fuel transfer pump and the fine filter. The gas discharging hole communicates with the fuel tank via the oil pipe. The hole diameter of the gas discharging hole is between 0.2 mm and 3 mm.

Preferably, the hole diameter of the gas discharging hole is preliminarily determined according to a following formula and confirmed by test verification:

$$d = 2 \sqrt{\frac{a}{π}} ; a = 2 PV / {v}^{2}$$

wherein d is the hole diameter of the gas discharging hole, P is a pressure in the fine filter, V is a volume of the fine filter, a is a cross-sectional area of the gas discharging hole, and v is a flow velocity of fuel.

Preferably, the gas discharging device is arranged on the fine filter.

Preferably, a fixing mount is arranged at an oil feeding port on a filter mount of the fine filter, and the gas discharging device is fixed to the fine filter via the fixing mount.

Compared with the prior art, the present invention has the following beneficial effects.

In the present invention, by arranging the gas discharging device at the oil feeding port of the fine filter, air in the fine filter can be discharged via the gas discharging device, thereby implementing active gas discharging, and effectively increasing activation performance of the engine. Compared with a scheme adopting an electronic fuel transfer pump, the present invention is ingenious in structure and high in reliability, and effectively reduces costs due to no additional control system. Compared with a scheme without an electronic fuel transfer pump, the present invention can significantly increase activation speed of an engine.

### BRIEF DESCRIPTION OF THE DRAWINGS

FIG. 1 is a schematic structural view of the present invention.

FIG. 2 is a structural block diagram of the present invention.

FIG. 3 is a flowchart of a method in the present invention.

FIG. 4 is a schematic structural view of a gas discharging device in the present invention.

FIG. 5 is a schematic view of a structural relationship between a fine filter and a gas discharging device in the present invention.

### DESCRIPTION OF THE EMBODIMENTS

The present invention is further described below with reference to embodiments, but does not constitute any limitation to the present invention, and any finite number of modifications made within the scope of the claims of the present invention are still within the scope of the claims of the present invention.

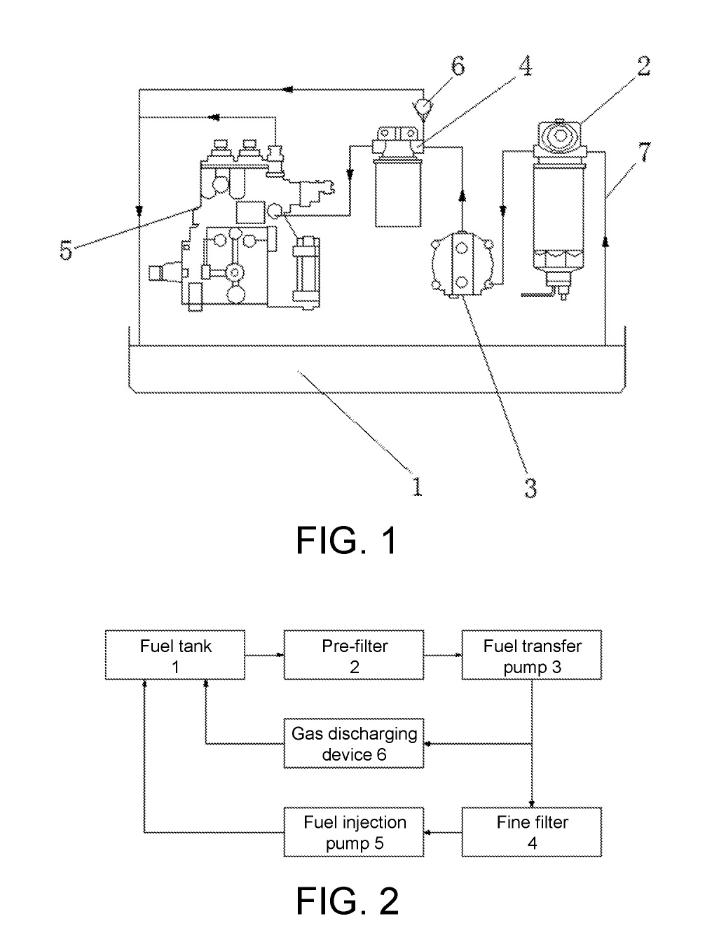

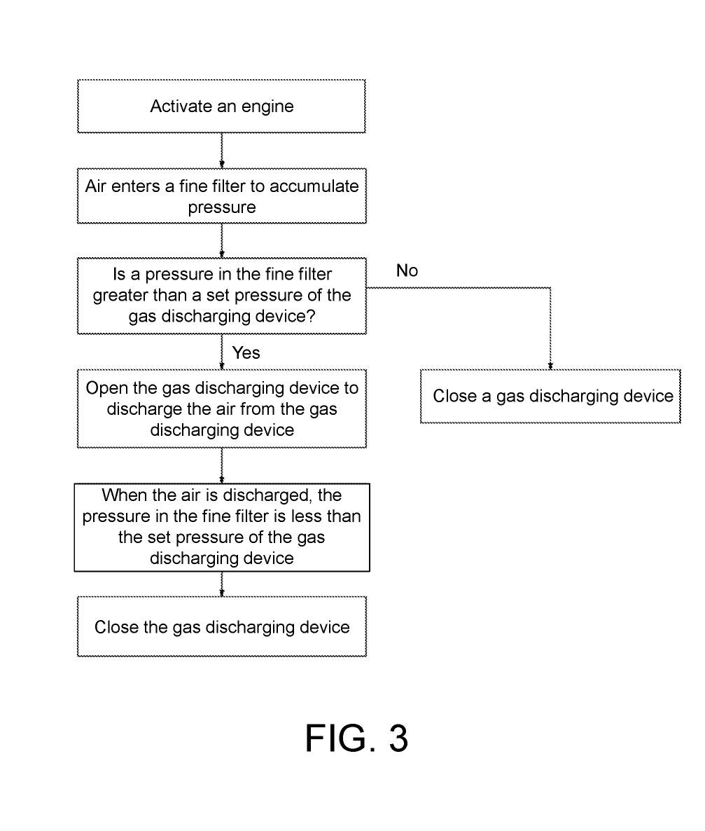

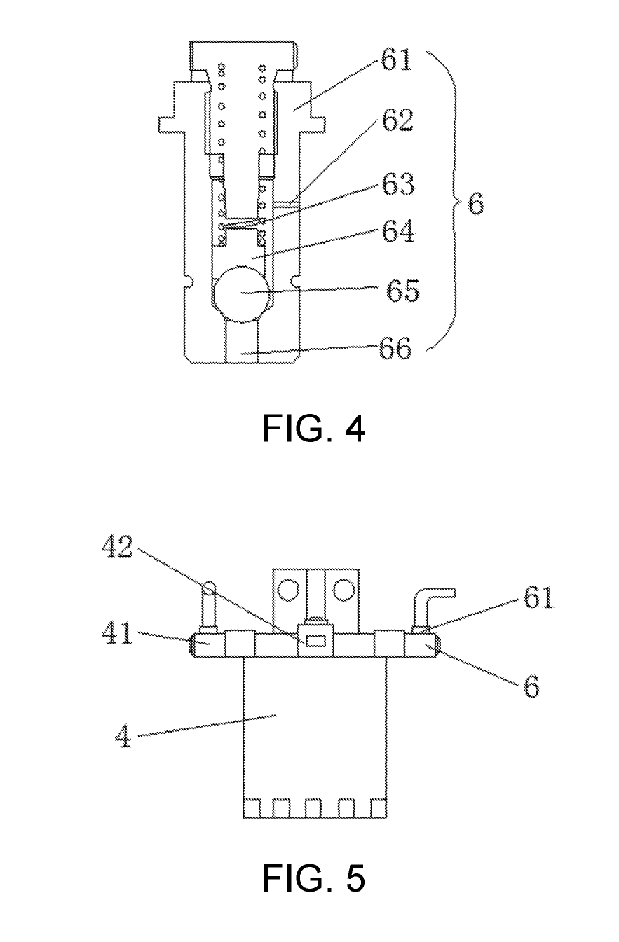

As shown in FIG. 1 to FIG. 5, the present invention provides a care-free activation system of an electrically controlled common rail engine. The system includes a fuel tank 1, a pre-filter 2, a fuel transfer pump 3, a fine filter 4, and a fuel injection pump 5. The fuel tank 1 is sequentially connected to the pre-filter 2, the fuel transfer pump 3, the fine filter 4, and the fuel injection pump 5 via an oil pipe 7. A fuel return port of the fuel injection pump 5 is also connected to the fuel tank 1 via the oil pipe 7. A gas discharging device 6 discharging fuel gas is arranged between the fuel transfer pump 3 and the fuel injection pump 5. An outlet of the gas discharging device 6 communicates with the fuel tank 1 via the oil pipe. A fixing mount 42 is arranged at an oil feeding port 41 of the fine filter 4. The gas discharging device 6 is fixed to the fine filter 4 via the fixing mount 42.

In the present embodiment, the gas discharging device 6 and the fixing mount 42 are connected tightly through screw threads to fix the gas discharging device 6 to the fine filter 4. An influence of vibration of an engine during normal operation on the gas discharging device 6 can be effectively avoided. Normal service life of the gas discharging device 6 can be prolonged, and operation stability can be increased. In addition, the gas discharging device 6 may also be connected to two segments of connecting oil pipe 7 between an oil outlet of the fuel transfer pump 3 and an oil inlet of the fuel injection pump 5 via a three-way joint.

The gas discharging device 6 is a one-way valve. The gas discharging device 6 includes a valve body 61, a valve body inlet 66 provided at one end of the valve body 61, and a gas discharging hole 62 provided on a side surface of the valve body 61. The valve body inlet 66 communicates with the fixing mount 42. The gas discharging hole 62 communicates with the fuel tank 1 via the oil pipe. A hole diameter of the gas discharging hole 62 is 0.5 mm.

The hole diameter of the gas discharging hole 62 is preliminarily determined according to a following formula and confirmed by test verification:

$$d = 2 \sqrt{\frac{a}{π}} ; a = 2 PV / {v}^{2}$$

wherein d is the hole diameter of the gas discharging hole 62, P is a pressure in the fine filter 4, V is a volume of the fine filter 4, a is a cross-sectional area of the gas discharging hole 62, and v is a flow velocity of fuel.

In the present embodiment, when calculating the hole diameter of the gas discharging hole 62, the hole diameter of the gas discharging hole 62 is preset according to the above formula with the experimental data before installing the gas discharging device 6, and the hole diameter of the gas discharging hole 62 is verified according to the above formula with the experimental data measured after installing the gas discharging device 6, so that the gas discharging device 6 can ensure sufficient gas discharging capability, and avoid excessive fuel flowing back to the fuel tank 1 via the gas discharging hole, thereby not affecting the normal operation of the engine.

An opening pressure of the one-way valve is 5 bar. In addition, the opening pressure of the one-way valve may also be 1.5 bar or 2 bar or 3 bar or 4 bar or 6 bar.

In addition, the hole diameter of the gas discharging hole 62 may also be 0.2 mm or 0.7 mm or 1 mm or 1.5 mm or 2 mm or 3 mm.

An operation process of the present embodiment is as follows: after the engine is activated to operate, fuel in the fuel tank 1 sequentially passes through the pre-filter 2, the fuel transfer pump 3 and the fine filter 4 via the oil pipe 7 and is then injected to the fuel injection pump 5. When there is air in the fine filter 4, pressure in the fine filter 4 is increased to push away a sealing steel ball 65 of the one-way valve 6, and the air in the fine filter 4 and part of the fuel enter the one-way valve 6 through the valve body inlet 66, pass through the gas discharging hole 62 in the side surface of the valve body 61 and are discharged back into the fuel tank 1 via the oil pipe 7; and when the air in the fine filter 4 is discharged, the intensity of pressure is lower than the pressure of a pressure limiting spring 63 against the sealing steel ball 65, such that the sealing steel ball 65 is in contact with the valve body inlet 66, the one-way valve 6 is closed, and the air in the fine filter 4 can be reduced, thereby shortening the next activation time of the engine and achieving a purpose of smooth activation.

The effect contrast between the present invention and the existing activation system of the electrically controlled common rail engine is shown in Table 1.

TABLE 1

| | | | | | | | | Axial | |
|---|---|---|---|---|---|---|---|---|---|
| | | | Axial | | | | Axial | pressure | |
| | Gas | | pressure | Axial | | | pressure | setup to | |
| Number | discharging | start | setup | pressure | Ignition | Activation | setup to | closed | successful |
| of tests | hole (mm) | drag (s) | start (s) | closed (s) | time (s) | time (s) | delay (s) | loop (s) | ignition (s) |
| | 0 | 7.014 | 8.794 | 9.324 | 9.364 | 2.66 | 1.78 | 0.53 | 0.31 |
| 1 | 0.5 | 4.838 | 5.666 | 6.066 | 6.186 | 1.619 | 0.828 | 0.4 | 0.271 |
| 2 | 0.5 | 5.926 | 6.836 | 7.307 | 7.467 | 1.77 | 0.91 | 0.471 | 0.229 |

It can be seen from Table 1 that the activation time of the present invention is significantly and effectively shortened compared to the activation time of the existing electrically controlled common rail engine, thereby effectively increasing activation performance of the engine.

The above is only a preferred implementation of the present invention, and it should be noted that those skilled in the art can make various modifications and improvements without departing from the structure of the present invention, and such modifications and improvements do not affect the implementation effects and applicability of the present invention.

1. A care-free activation system of an electrically controlled common rail engine, comprising a fuel tank, a fuel transfer pump, a fine filter, and a fuel injection pump, wherein a gas discharging device (6) discharging fuel gas is arranged on an oil channel between an oil outlet of the fuel transfer pump and an oil inlet of the fuel injection pump, and an outlet of the gas discharging device communicates with the fuel tank via an oil pipe.

2. The care-free activation system of the electrically controlled common rail engine according to claim 1, wherein the gas discharging device is a one-way valve.

3. The care-free activation system of the electrically controlled common rail engine according to claim 2, wherein an opening pressure of the gas discharging device is between 1.5 bar and 6 bar.

4. The care-free activation system of the electrically controlled common rail engine according to claim 2, wherein the gas discharging device comprises a valve body, a valve body inlet provided at one end of the valve body, and a gas discharging hole provided on a side surface of the valve body, the valve body inlet communicating with the oil channel between the oil outlet of the fuel transfer pump and the fine filter, the gas discharging hole communicating with the fuel tank via the oil pipe, a hole diameter of the gas discharging hole is between 0.2 mm and 3 mm.

5. The care-free activation system of the electrically controlled common rail engine according to claim 4, wherein the hole diameter of the gas discharging hole is preliminarily determined according to a following formula and confirmed by test verification:
$$d = 2 \sqrt{\frac{a}{π}} ; a = 2 PV / {v}^{2}$$
wherein d is the hole diameter of the gas discharging hole, P is a pressure in the fine filter, V is a volume of the fine filter, a is a cross-sectional area of the gas discharging hole, and v is a flow velocity of fuel.

6. The care-free activation system of the electrically controlled common rail engine according to claim 2, wherein the gas discharging device is arranged on the fine filter.

7. The care-free activation system of the electrically controlled common rail engine according to claim 6, wherein a fixing mount is arranged at an oil feeding port on a filter mount of the fine filter, and the gas discharging device is fixed to the fine filter via the fixing mount.
